(19) United States
(12) Patent Application Publication
(10) Pub. No.: US 2015/0040020 A1
(43) Pub. Date: Feb. 5, 2015

(54) CLICKSTREAM MONITORING

(71) Applicant: Been, Inc., New York, NY (US)

(72) Inventors: David H Yoon, New York, NY (US); Sang Y Shin, San Jose, CA (US)

(21) Appl. No.: 14/449,073

(22) Filed: Jul. 31, 2014

Related U.S. Application Data
(60) Provisional application No. 61/860,391, filed on Jul. 31, 2013.
(60) Provisional application No. 61/860,453, filed on Jul. 31, 2013.
(60) Provisional application No. 61/860,465, filed on Jul. 31, 2013.

(51) Int. Cl. H04L 29/08; G06F 3/0481; G06F 17/30; G06Q 30/02

(52) U.S. Cl. CPC H04L 67/22; G06Q 30/0201; G06F 3/04817; G06F 17/30887
USPC 715/738; 705/7.29

(57) ABSTRACT

A computer platform and network for sharing of clickstreams and demographic information of users browsing the Internet with content providers and advertisers. The technology further relates to a graphical user interface for representing clickstreams and selectively recorded URL's/URI's for individuals and groups of individuals in both linear and popular (most visited) views. The technology still further includes permitting an intentional delay in recording URL's/URI's via the graphical interface, with controls for the user to control or override the delay.

### CLAIM OF PRIORITY

This application claims the benefit of priority under 35 U.S.C. §119(e) to U.S. provisional application serial nos. 61/860,391, filed Jul. 31, 2013, 61/860,453, filed Jul. 31, 2013, and 61/860,465, filed Jul. 31, 2013, all of which are incorporated herein by reference in their entirety.

### RELATED APPLICATIONS

The instant application is also related to the following U.S. provisional patent applications, all of which are incorporated herein by reference in their entireties:
Yoon, D., et al., application Ser. No. 61/860,408, filed Jul. 31, 2013, entitled “GRAPHICAL INTERFACE AND DATABASE FOR CLICKSTREAM MONITORING AMONGST GROUPS OF USERS”, attorney docket no. 1757-00-003P01;
Yoon, D., et al., application Ser. No. 61/860,417, filed Jul. 31, 2013, entitled “SYNCHRONIZED WEB BROWSING IN REAL TIME”, attorney docket no. 1757-00-004P01; and
Yoon, D., et al., application Ser. No. 61/860,431, filed Jul. 31, 2013, entitled “CONTENT TAGGED TO WEB-PAGES”, attorney docket no. 1757-00-005P01.

### TECHNICAL FIELD

The technology described herein generally relates to a platform and network for sharing of clickstreams and demographic information of users browsing the Internet with content providers and advertisers. The technology described herein further relates to a graphical user interface for representing clickstreams and selectively recorded URL's/URI's for individuals and groups of individuals in both linear and popular (most visited) views. The technology described herein further includes permitting an intentional delay in recording URL's/URI's via the graphical interface.

### BACKGROUND

The clickstreams of Internet users arguably rank as some of the most valuable information available for understanding users' needs and preferences, both online and offline. They help identify and estimate the impact of the information the users receive and create, as well as how their opinions, tastes, and preferences form and change over time. Furthermore, due to the ease and speed with which users of the Internet can browse multiple web pages in any given amount of time, it has become more and more difficult for anyone to assess and take stock of the information encountered while browsing.

Today, organizations (both commercial and otherwise) seek this information to identify and target users with content and advertisements. The dominant paradigm for doing this is to track data in the “background,” avoiding as much as possible an explicit dialog with, and assent of, the users whose data is being captured, thereby avoiding disclosing the extent of the tracking and the value of the tracked information to the organization. One way for this dominant paradigm to shift is to have the users collect their own clickstreams. In many ways, voluntary recordings of users' clickstreams by the users themselves would be superior to the “background” recordings by third parties.

Even so, the possibility of an unwanted recording is one of the most imposing impediments to effecting change. Users need to feel absolutely certain that only the web pages, URL's/URI's, that they want recorded are recorded. This is true even with the ability to erase recordings after the fact.

Accordingly, there is a need for a platform that allows for both more useful data for the creation of personalized and targeted content and advertisements, as well as greater control of the sharing of user clickstreams by the users themselves.

Such a platform should have a capability by which users can navigate to a new web page, while in a recording session through an application that records their URL's/URI's (uniform resource locators/uniform resource identifiers), to prevent that new web page from being recorded.

Furthermore, given the value present in clickstreams, other tools to facilitate their analysis would be beneficial. Though there exist applications to show visual representations of a series of web pages browsed, or text lists, and text lists of most often visited pages, much additional information could be provided if ways could be found to quickly and efficiently display a user's browsing history in a manner that highlighted sites that the user found popular as well as those found popular within the user's community.

The discussion of the background herein is included to explain the context of the technology. This is not to be taken as an admission that any of the material referred to was published, known, or part of the common general knowledge as at the priority date of any of the claims found appended hereto.

Throughout the description and claims of the specification the word “comprise” and variations thereof, such as “comprising” and “comprises”, is not intended to exclude other additives, components, integers or steps.

### SUMMARY

The instant disclosure addresses the recording and sharing of a user's clickstreams, in conjunction with a server. In particular, the disclosure comprises a computer program configured to permit one or more users to record and share their clickstreams, the computer program being executable as a browser extension on a desktop or laptop computer, or as an app on a mobile device, wherein the computer or mobile device is in communication via a network connection with a server.

The present disclosure provides for a computing apparatus for managing a user's clickstreams, the apparatus comprising: an Internet connection; a computer-readable memory, encoded with instructions; a processor executing the instructions; wherein the instructions provide for: recording a user's clickstream, wherein the clickstream comprises two or more URL's from the user's Internet session; associating one or more pieces of user-specific information with each of the two or more URL's; and sharing the clickstream with one or more third parties.

The present disclosure further provides for a method for managing a user's clickstreams, the method comprising: recording a user's clickstream, wherein the clickstream comprises two or more URL's from the user's Internet session; associating one or more pieces of user-specific information with each of the two or more URL's; and sharing the clickstream with one or more third parties, wherein the method is performed on a computing apparatus. The disclosure further includes a computer-readable medium encoded with instructions for implementing the foregoing method for managing a user's clickstreams.

The present disclosure still further provides for a computing apparatus for displaying a user's clickstream, the apparatus comprising: an Internet connection; a computer-readable memory, encoded with instructions; a processor executing the instructions; wherein the instructions provide for: recording the clickstream of a user, wherein the clickstream comprises one or more URL's from the user's Internet session; storing the clickstream in a database; generating an icon for each of the one or more URL's based on the length of time spent by the user at the URL; and displaying, on a computer display, the icon for each of the one or more URL's.

The present disclosure additionally provides for a method for displaying a user's clickstream, the method comprising: recording the clickstream of a user, wherein the clickstream comprises one or more URL's from the user's Internet session; storing the clickstream in a database; generating an icon for each of the one or more URL's based on the length of time spent by the user at the URL; and displaying, on a computer display, the icon for each of the one or more URL's; wherein the method is performed on a computing apparatus. The present disclosure further provides for a computer-readable medium encoded with instructions for implementing the foregoing method for displaying a user's clickstream.

The present disclosure additionally includes a computing apparatus for, while recording a user's clickstream, introducing a delay in recording web pages as part of the use's clickstream, with the ability to override that delay by the user, the apparatus comprising: an Internet connection; a computer-readable memory, encoded with instructions; a processor executing the instructions; wherein the instructions provide for: recording a user's clickstream; producing a delay in the recording of a URL that the user browses to, wherein the delay can be overridden by navigating to another URL, or by instructing the web browser extension; and visually informing the user of both the delay and, after the delay period has passed, the recording of the URL to the user's clickstream database.

The disclosure further provides a method of, while recording a user's clickstream, introducing a delay in recording of web pages, the method comprising: recording a user's clickstream; setting a delay in the recording of a URL to be a certain amount of time after the navigation to that URL; recording the URL after the delay period has passed, or if the user navigates to another page within the period of the delay, or if the user instructs the web browser extension to override the delay; visually displaying the delay and the end of the delay and the recording the URL; and storing the user's URL into the clickstream in the database; wherein the method is performed on a computing apparatus. The disclosure also comprises a computer-readable medium encoded with instructions for implementing the foregoing method of, while recording a user's clickstream, introducing a delay in recording of web pages.

### BRIEF DESCRIPTION OF THE DRAWINGS

FIG. 1 shows a selection of exemplary icons that can be associated with URL's.

FIG. 2 shows an exemplary browser-based recording interface, with notification of a delay in recording when a user navigates to a new page;

FIG. 3 shows an exemplary data structure for storing group properties with recorded URL/URI data;

FIG. 4 shows an exemplary graphical view of selectively recorded URL's/URI's or chronological clickstreams wherein web-pages are depicted by thumbnails.

FIG. 5 shows an exemplary graphical view of selectively recorded URL's/URI's or chronological clickstreams sorted by popularity over different time periods, where web-pages are depicted by thumbnails based on popularity.

FIG. 6 shows a tabular view of textual descriptions of combined clickstreams of a group of users.

FIG. 7 shows a schematic implementation of the technology herein on a client device.

FIG. 8 shows a schematic diagram of a computer configured to run the clickstream monitoring programs described herein.

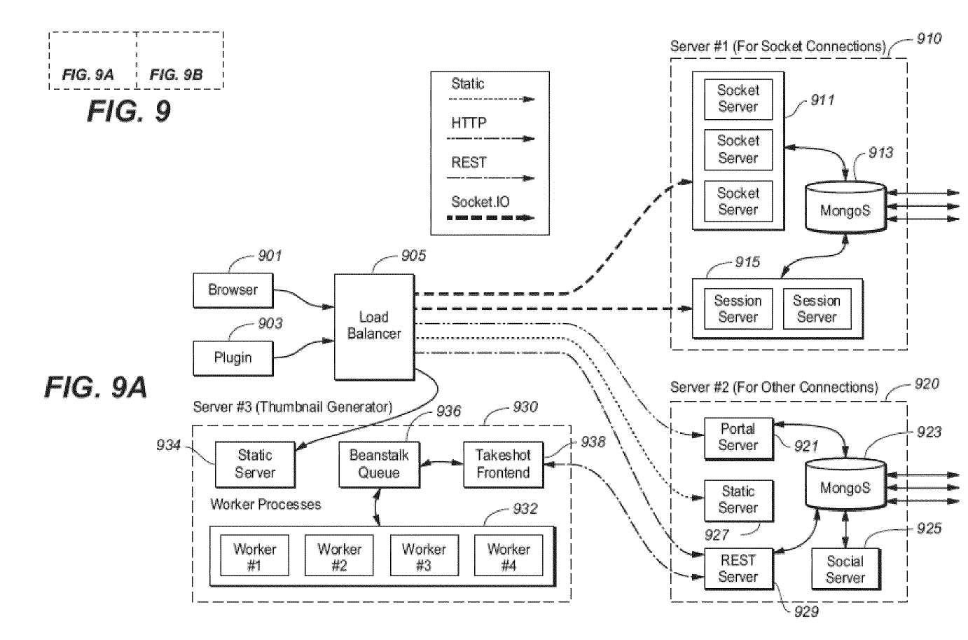

FIGS. 9A and 9B show an end to end system diagram.

Like reference symbols in the various drawings indicate like elements.

### DETAILED DESCRIPTION

The technology described herein comprises a platform that allows for both the creation of personalized and targeted content and advertisements, and control of the sharing of user clickstreams by the users themselves.

In particular, the instant technology includes a method for acquiring, storing, calculating, and displaying Internet/intranet URL/URI navigation histories of individual users as well as groups of users, either selectively or comprehensively. Calculations can be carried out by, for example, grouping data and ranking them according to factors such as the number of individual views, the average duration of time spent on a URL/URI, and number of referrers. Groups of users can be both voluntarily formed (e.g., by the users themselves), or formed for analytical purposes to identify and understand distinct behavioral segments in populations.

It is to be understood that the technology, for example the server, is compatible with any client-side device.

Accordingly, the technology herein is compatible with any web-browser software, including but not limited to: Internet Explorer, Safari, Chrome, FireFox, and Opera, and any version thereof.

On mobile devices, the technology is compatible with application software, such as iOS, Android, Windows operating systems, and any versions thereof.

### DEFINITIONS

URL and URI—uniform resource locator and uniform resource identifier, respectively. It is assumed herein that a reference to any one of: URL/URI, URI, or a URL means either a URL or a URI or both.

Clickstream—an individual's Internet and Intranet browsing history, which is a collection of URL's/URI's that the individual accesses and views in sequence. The term “clickstream” may also be written as “click-stream” or “click stream” herein, without changing its meaning.

Internet Browsing Device—a combination of hardware and software components that enables a user to view and update content on the Internet, the device including, but not limited to desktop computers, and mobile devices such as laptops, notebooks, smart phones, and tablets.

Browser extension—a computer program that extends the functionality of a web browser.

API—an application programming interface that functions over the standard Internet and intranet communication protocols, which enables disparate web sites and web applications implemented in different technology stacks to exchange and process data securely with each other.

Referrer—the preceding URL/URI that a user was viewing before loading another URL/URI. There are many use cases that fall under this definition. The preceding URL/URI could be a web page from which the user clicked a link to navigate to another page. It can also be the prior tab or window the user was viewing before switching to another tab or window. It can also be the currently-loaded web page before a user types a new URL/URI in a browser's address bar and hits “enter” or “return”.

Advertising and Auction Exchange—a marketplace where user data can be put up for sale and offered for purchase by commercial or noncommercial organizations or individuals, or put up for auction to be bid by commercial or noncommercial organizations or individuals.

Browser extension—a computer program that extends the functionality of a web browser.

### Overview

The instant technology is directed to systems and methods for recording and organizing users' click streams, and to providing methods of sharing the same.

The instant technology further includes a graphical user interface for representing click-streams for individuals and groups of individuals. An efficient visual representation of these ordered browsing histories constitutes a tool for both archival and discovery.

A preferred implementation of the technology is a client such as an Internet browser extension (or “add on”) used in conjunction with an Internet browser, such as Internet Explorer, Safari, FireFox, Chrome, or Opera, or a mobile device running an app that connects to the server.

### Recording

The methods described herein allow for the display of a series of web pages as thumbnails that can be customized by any or all of the following parameters: time period viewed by the user and/or voluntary or otherwise comprised groups of individuals, subject matter. The display can be in either time series format, or an order ranked by the number of visits or duration of views. It is to be understood that the foregoing list of parameters is not exclusive or exhaustive.

The ability to show a time series of web pages (URL/URIs) visited as well as a ranked order for a group of users can become useful where, for example, the users in the group have similar interests, the group is researching the same subject matter, the group is comprised of members from the same family, friendship group, commercial or fraternal organization, as well as other possibilities. An ordered representation of the web browsing history provides the group members the ability to narrow their browsing in search of relevant information as well as share their own histories passively. It becomes a tool by which material may be discovered that may be only tangential to a particular topic of interest but is in fact potentially relevant to it.

A collection of Internet/intranet URL/URI browsing histories for an individual or a group of individuals can be collected, and can have a number of associated characteristics, any of which can be recorded to a database. Creating a database of such characteristics provides a convenient mechanism for managing and manipulating the data underlying a clickstream.

Users can record groups of clickstreams, created for example in the context of a targeted search or browsing session, in order to share with companies that can provide services in return, thereby making the users' clickstreams topic-specific and more likely to be relevant to a potential transaction with the third party. For example, a user carries out a sequence of searches in connection with a vacation plan, and browses web-sites associated with flight and hotel booking, rental car reservation, and admission tickets for attractions at the vacation location. Users can also record to a single place, across multiple devices, and multiple browsing applications, because the clickstream data is stored on a server in an account associated with the user.

Recording, editing, and viewing of clickstreams, and creating chronological/historical lists of behavior on the Internet, can be accomplished by the following functions:
a. URL's/URI's are recorded to a database as users browse the Internet or an intranet, across multiple devices, operating systems, and applications, wherever and whenever the user has switched the recording function to on to record.
b. URL's/URI's can be recorded into user-created files (for example, denoted by a distinctive graphical icon and user-determined name for that file), and there can be multiple files for each user.
c. Each URL/URI visited can be recorded to multiple files simultaneously. Users can determine whether a page loaded into the browser is recorded or not, and whether it is recorded to a single file or recorded to multiple files.
d. There can be a fixed time duration delay in recording a URL/URI when a user navigates to a new URL/URI to allow for prevention of recording should the user prefer not to record the new URL.
e. Users can edit the recordings after URL's/URI's have been recorded by deleting the URL's/URI's that they do not want in their recordings, using either a text-based interface or a graphical interface.
f. Users can view their recordings of URL's/URI's recorded within each file/grouping, through either a text-based interface or a graphical interface, with each page visited being represented, for example, as a separate icon. The order by which the recorded pages are displayed can be alternated by the user between chronological (the chronological order by which the user recorded the pages) and most-visited, as well as other orderings such as by subject grouping, or by alphabetical order of page title.

### Data Exchange

One valuable aspect of the technology described herein is the capability for third parties to access a user's clickstreams, or the clickstreams of groups of users, by consent from users and in a manner that users can control. Thus the third parties receive data that is of higher quality and integrity than if they were attempting to obtain equivalent information by randomly intercepting a user's online activities.

Sharing of recordings with third parties can be accomplished according to the following options and limitations.

Users are able to share their recordings of URL's/URI's with third parties, combined or not combined with their volunteered demographic, personal, and contact information.

Users may or may not receive in-kind or monetary compensation in return for sharing the data. Content providers and advertisers may tailor the content and the advertisements on a given web page based on the data shared by the user. The compensation can also be of a direct donation of a financial incentive to a non-profit or charity of the user's choice.

Sharing can be done on a real-time basis. For example, users can go to a web page or web site and choose to share a set of recordings with either the content provider or the advertisers on that web page.

Sharing can also be done on a continuous basis, where users agree to allow that the sharing is performed in the “background” continuously as they go from web page to web page and from web site to web site, through a common information exchange and processing mechanism that web site operators and/or Advertising and Auction Exchange implement.

The common information exchange and processing mechanism can be facilitated through an API that will allow content providers, advertisers, and advertising and auction exchange to accept and read the recordings and ancillary data shared by the users and change the content and/or the advertisements on the web page based on this information.

The act of sharing of the data can be executed by the user either through a graphical interface or a text-based setting. An example of a graphical interface would be the dragging and dropping of the icons representing different sets of data, including users' demographic information and clickstreams onto the web page that offers to accept the data.

### Supporting Database Structure

The database can be SQL or NoSQL in structure, although having a NoSQL structure may be more efficient for data transport using common Internet data objects such as JSON or JSONP. In such an implementation, a NoSQL database such as MongoDB could be exposed via an API architecture using Python such as PyMongo. The API could then be connected to web services running on web servers which would transmit JSON data with clients that have the browser extensions installed.

In a larger scale deployment (>10,000 concurrent users), socket services and servers can be used to service a large number of concurrent API requests from clients.

Chronological views with linear data sets are relatively straightforward to service via API requests into the database. Whether the chronological view request is for an individual user or for a group of users, all the database has to execute is a sort of the clickstreams by access times, which as described elsewhere herein, are stored in UTC format.

Popular views can present a performance challenge as they are grouped in different time periods per file, with each file containing one or more users' data. Calculating popular views on-demand will not be scalable, even with large hardware deployments. As such, regardless of whether a SQL or NoSQL database structure is employed, some batch background processes will need to be implemented to essentially pre-calculate or ‘cache’ the popular view data for the files, for different time periods.

Additionally, the ability to show the most frequent destinations navigated to from the URL/URI represented by the current leaf, of users recording to a file will need to be calculated using the referrer data. The URL/URI represented by the current leaf may have referrer data from the user(s) who recorded the URL/URI into the file. The database will aggregate the referrer data from the user(s) who recorded the URL/URI to the file and store, as part of its batch process, the top five URLs for which the current URL/URI is the referrer for, and continue this process for as many levels as configured by the site administrator.

By implementing the above background batch processes, one skilled in the field of database architecture and development could construct a supporting infrastructure that could, when combined with a socket server deployment layer, scale to serve a large number of clients without degraded performance.

### Storage of URL/URI Histories

The recorded URL/URI histories will reside in a persistent storage medium such as a database. The important requirement when storing the data is that each URL/URI, along with all of its recorded properties including, but not limited to, time of access, duration of access, referring URL/URI, can be tagged as being part of one or more of the groups so that the data can be aggregated and structured for display and management in a flexible and expedient manner.

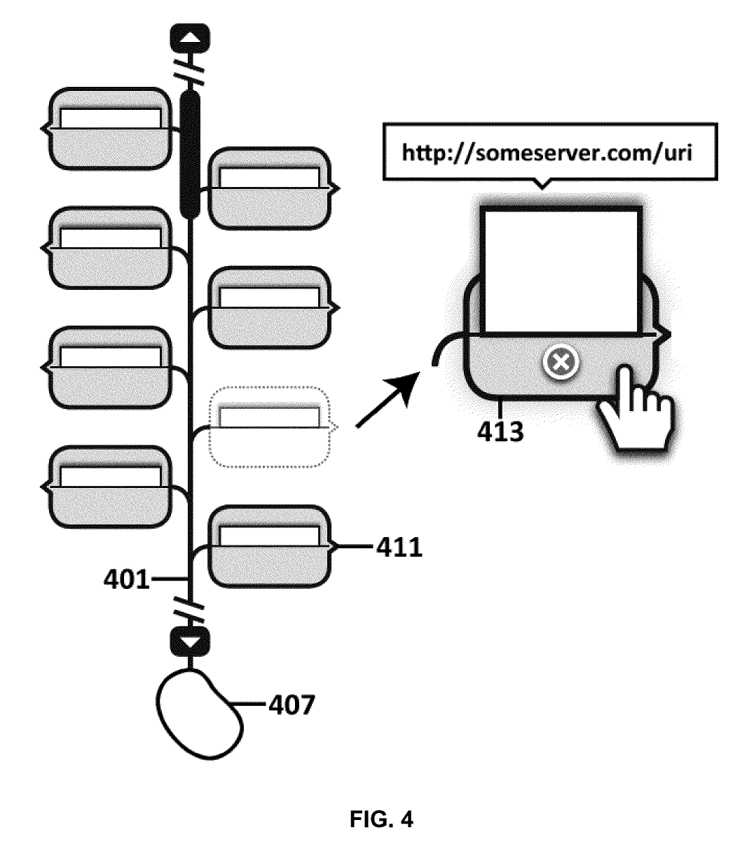

One example of how to implement this would be to use a NoSQL database like MongoDB and python via PyMongo to create the data structure shown in FIG. 3 to store each URL/URI (referred to as PageView in the example). Note how, in this example, BSON is used to maximize performance (BSON is a binary-encoded serialization of JSON-like documents).

### Display

The browsing histories can be linked to the personal and demographic information (e.g., name, age, gender, location) and contact information of the user (e.g., e-mail address, mailing address, phone), as provided by the user or as gleaned by the system from other sources on the user's Internet browsing device.

URL's/URI's are recorded when loaded in an Internet browsing device. A URL/URI is recorded if any one of the following conditions is met:
a. The loaded URL/URI stays loaded for at least a pre-set interval of time;
b. The user navigates away from the loaded URL/URI within a pre-set interval of time; and
c. The Internet browsing device's tab/window that displays the loaded URL/URI is moved to the background by bringing another window/tab to the foreground within a pre-set interval of time.

The pre-set interval of time applicable to a-c can be chosen by the user, such as selected from a list of pre-defined times (for example 0.5, 1, 2, 3, 5, 10 s), or can be set to a value chosen by the user. The application initially assigns the pre-set interval of time a default value, such as 5 s.

Time data can be recorded for each URL/URI and can comprise the time stamp (e.g., in Coordinated Universal Time (UTC)) of when URL/URI is recorded, and, optionally, the length of time spent on a URL/URI before navigating away or bringing another tab or window to the foreground or into focus.

Other web page properties that can be recorded include one or more of: Web page title (e.g., from value in the <Title> HTML tag if available); Referrer (e.g., the HTTP referrer as defined by the W3C (i.e., current web page accessed by clicking on a hyperlink from the previous web page); the Web page that was previously loaded before manually typing in a new web page address; and the Web page of the previous tab if another tab is brought to the foreground); thumbnails of web pages, generated by a separate thumbnail server accessing saved URLs so that no personalized/private content is in the thumbnails; favicons (a set of icons associated with a particular Web Site or Web Page) of URLs (domains) visited; Viewport scrolling coordinates when “Surfing Together” (an activity during which members of the group access the same web-site at the same time); Flag for marking a web page as a favorite; Notes dropped on web pages (free form content created and saved for oneself or for others associated with a URL/URI); Browser type and version used to view the web page; and Operating system type and version used to view the web page. It is to be understood that this list is not exhaustive or exclusive and that other properties of web-pages can be recorded in addition to or in place any one of the foregoing properties. Ways to accomplish “surfing together” are described in copending application Ser. No. 14/______, filed Jul. 31, 2014, entitled “Synchronized Web-browsing”, having first-named inventor Yoon, David, and attorney docket no. 1757-00-003U01, incorporated herein by reference.

Preferably at least one item, e.g., the time-stamp, is recorded to a database.

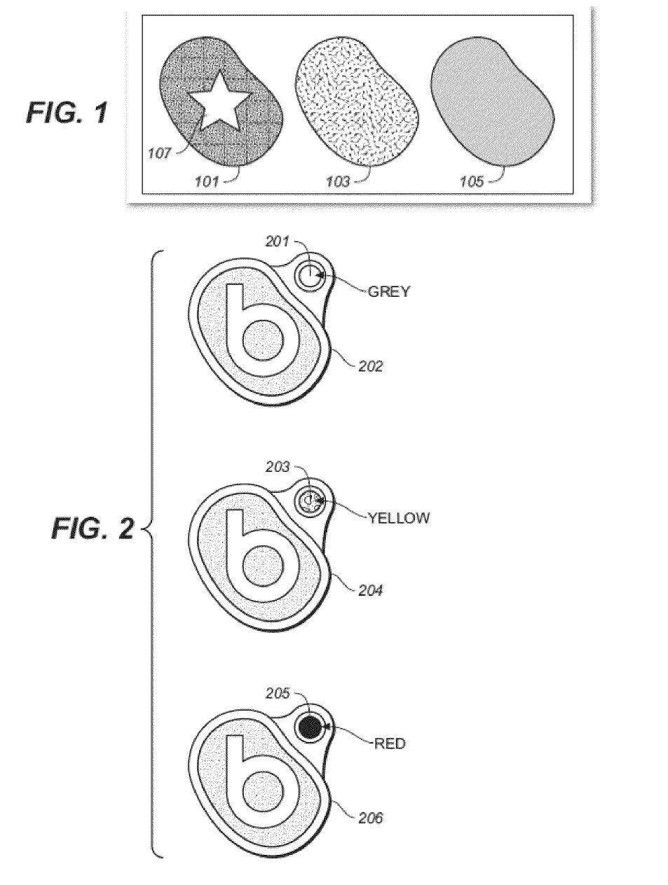

From this database, each collection of URLs can be represented as a file that includes some or all of the above data. A collection of URLs and their associated data created by the navigation behavior of a selection/subset of the population of users can be represented graphically by icons such as those shown as items 101, 103, and 105 in FIG. 1.

Each such icon 101, 103, 105 in FIG. 1 represents a file, or one or more data fields identifiable by a unique identification code in the database, which contains the Internet browsing histories of an individual or a group of individuals, bounded within certain time periods. Each individual or a group of individuals can have more than one file (and icon representing the file), with the same histories or different histories. The icons, in the example of FIG. 1, resemble beans in shape though other shapes such as circles, ovals, or polygons, are consistent with the operation of the technology. Each icon represents a file of the history of where an individual or a group of individuals haven been on the Internet/intranet, in a given amount of time, or in search of a topic of interest. Other commonalities of purpose may also be used to generate such an icon. For example, one bean (101 shown here with a star 107) can indicate a URL/URI visited heavily, or which has received favorable commentaries from users. The icons can be decorated in various ways to differentiate and distinguish them one from another. For example, different color schemes, shading, borders, fill-patterns, and motifs can be used, as is indicated verbally and by shading in FIG. 1. In a computer display, the icons are typically displayed overlaying a browser window in an unobtrusive manner. On a mobile device, the icons are typically displayed within the application, for example in a list or tabular format. The mobile device application then runs a browser from within it. That browser can be the phone's native browser (e.g., Safari on iOS) or can be a custom browser built for the app from native browser code.

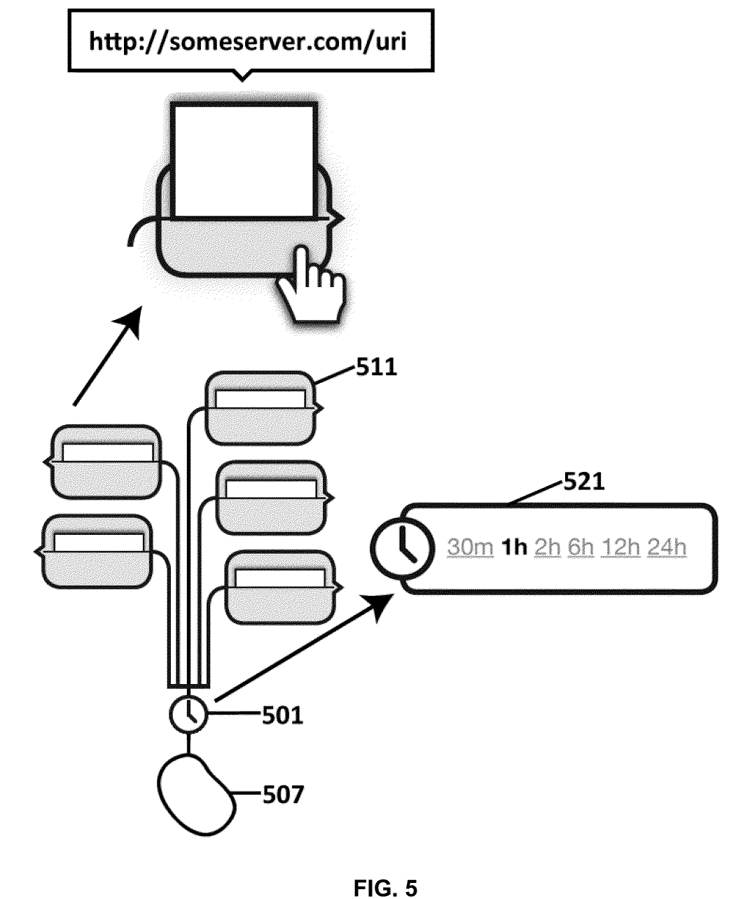

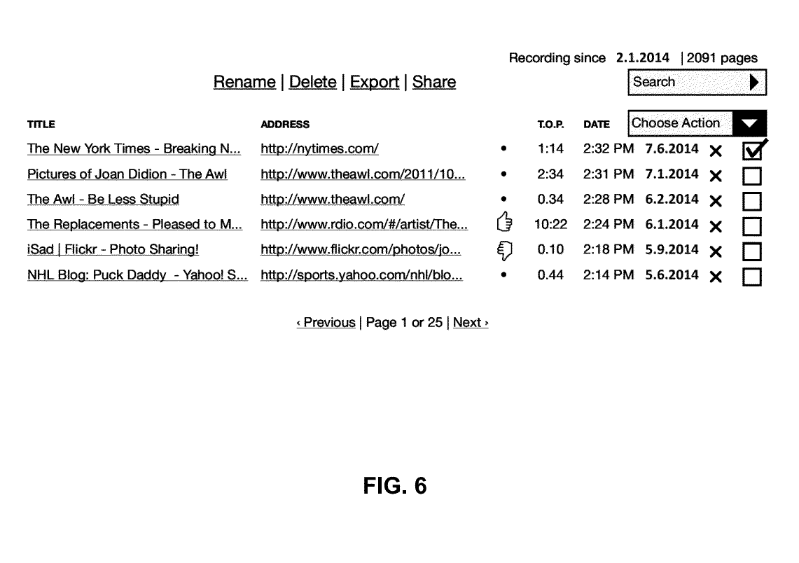

The icons are selectable in the sense that clicking on one (for example with a mouse-controlled cursor on a desktop computer, or with a finger-tap on a mobile device) will reveal the underlying clickstream information associated with the icon. Two possible graphical representations to help viewers visualize the recorded browsing/navigation histories are: (1) chronological (FIG. 4), and (2) popular (FIG. 5, e.g., based on frequency of visits within a specified time period).

The chronological view is a linear set of pages represented by thumbnails of the contents linked to a URL/URI. An example is shown in FIG. 4. The pages, such as 411, broadly resemble leaves, on a stalk 401, within which the thumbnails of the contents of the URLs are partially or fully overlaid. A method for viewing more than a limited number of URL-indexed pages in thumbnail form allows for scrolling to display additional thumbnails, organized chronologically. Clicking on any leaf will take the viewer to the URL/URI associated with the depicted web-page typically by launching a web-browser or by opening the page within an already-running browser. As shown, a leaf associated with a particular web-page 413 may be selected and deleted from the view.

The set of URLs and their linked contents can also be displayed in a visually-ordered way using, for example, the following approaches:
A set of leaves (five in the example shown in FIG. 5) represents the most visited URLs in a specified time period by an individual recording their Internet browsing history to the particular file. Each leaf 511 has a URL/URI and a thumbnail webpage associated with it. Button 501 for example, enables a user to determine the time period. Clicking on button 501 reveals a menu 521 of time periods permitting a user to select the desired one.
The relative and/or absolute area of the leaves can be determined by the relative popularity (or frequency) of the URLs and associated thumbnails in the database within a specified time period.
Additionally, another attribute of the way the leaves are displayed (for example the color), is determined by how long, on average, users stay on a particular page. Other attributes of the leaves can represent aspects such as whether users have linked text specific to that page, and the degree to which users like or dislike a page.
Clicking on a leaf will load, in a web browser, the URL/URI associated with the thumbnail on the leaf, as shown in FIG. 5 for the leaf associated with the URL someserver.com/uri.
There can also be an icon on the leaf to show a set of additional leaves, representing the most frequent destinations navigated to from the URL/URI represented by that leaf, of users recording to this file.

### Delayed Recording

The instant technology is further directed to providing, while recording a user's clickstream, a method to delay recording a web page to prevent unwanted recordings while browsing through a series of URL's/URI's, and an interface to notify the user of the delay as well as options for overriding the introduced delay.

This technology is a method for, while recording a user's clickstream, introducing a delay to the recording of clickstreams when a user navigates to a web page. The purpose of a delay is to provide an additional level of safety and peace of mind to the user who wishes to record their clickstreams, for their own use, or to share with others, including companies who could use the data to provide a better web experience to the user. The measure of safety and peace of mind is due to knowledge that should they navigate to a page that they do not want recorded to any database, whether to be shared with others or kept in private possession, that they have time to prevent the recording of such page.

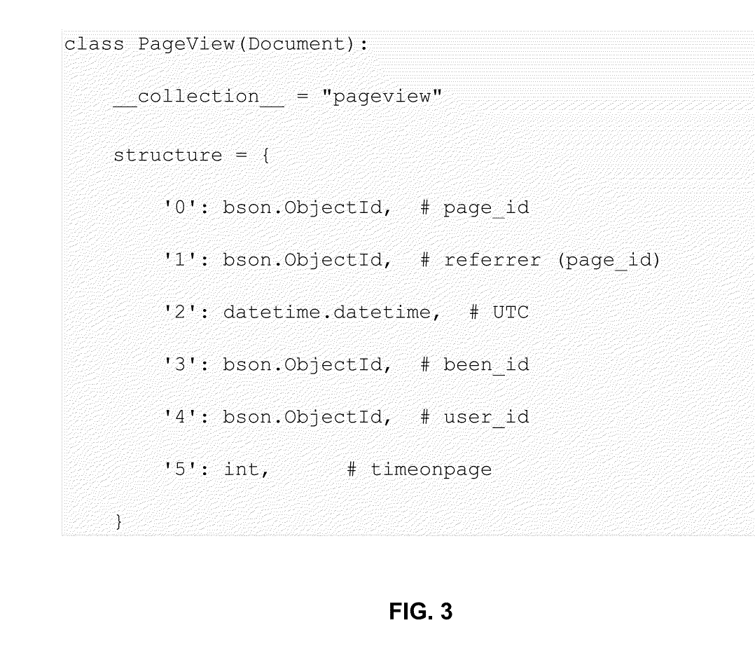

Via a graphical interface, the user is informed of both the initiation of the delay and its termination, at which point the URL that the user has navigated to is recorded to the database. FIG. 2 demonstrates such an exemplary interface in which each icon has a control feature. Thus, in FIG. 2, icons 201, 204, 206 each have a button (respectively 201, 203, and 205) which is selectable independently of the icon itself to which it is attached. The buttons control recording, by being clicked to initiate and terminate recording. Typically the button indicates the state of recording so that the user can tell immediately whether recording is taking place. For example, this could be by changing color according to state. Button 201 is grey, meaning that recording is not taking place. Button 203 is yellow meaning that the current page displayed in the browser is about to be recorded. The user has a time period (say 10 s) to prevent the current webpage from being recorded. If the user navigates to another web-page while the button is yellow, the first page will be recorded. Button 205 is red meaning that the current page has been recorded already. Other color schemes or manners of indicating the state of recording (e.g., by flags) are consistent with the technology herein. During the set delay interval, the user will be informed that the page that they are on has not yet been recorded to the clickstream record.

During this time interval, the user can override the delay by either (a) navigating to another page (for those users who would like to record a series of URLs in quick succession without being encumbered by the delay technology) and (b) instructing that the current URL should be recorded without delay. The delay mechanism is the default method but can be overridden to provide a balance between privacy and convenience.

The delay functionality described herein should not cause undue inconvenience to the user who wishes to record a series of webpages, URLs/URIs, in quick succession. The balance between convenience (recording many pages) and safety (a delay that allows users to prevent recording during a set period of time, e.g., 10 seconds) is struck by the ability of users to record the URL/URI if they navigate to another page within the duration of the delay. In other words, when users land on a new page, a delay is initiated which gives users the ability to choose not to record that page. However, should they navigate to another page during the initiated delay, that page will be recorded. And the delay will start again in this next page. Another way to override the delay, for example, would be to stay on the original page but signal to the web browsing extension to record the page without delay.

### Calculating and Viewing Histories Based on Group Viewing

At any time, a user who is a member of the group, or a third party with permission from a member of the group, may view the recording in multiple formats: either chronologically or most-visited within a certain user-chosen time interval by the entire membership in the group, e.g., last hour, last 24-hour period, last month, last year, or within a specified time period (e.g., between 2 am GMT Jan. 2, 2013 and 7 pm GMT Feb. 15, 2014).

The chronological and most-visited within a time period results can be viewed in tabular/textual format and in graphical form. In graphical form, the chronological view can be a linear view of icons representing the URL's, i.e., thumbnails or images of the actual URL's/URI's. FIG. 4 shows an example of how the chronological graphical view of combined clickstreams of a group could look like, for example when run from a browser extension on a desktop or laptop, or when run as an app on a mobile device.

The graphical form of the most-visited within a time period list will use different sizes of the thumbnails or images to reflect the ranking of the URL's/URI's, from the most visited URL/URI to the least visited, respectively for each time period.

For any given time period, the program will scan URL's/URI's that fall within the specified timeframe and that have the group ID tagged to them. The program will then determine, within that collection, the URL's/URI's that have been viewed the most (by count) by the members of the group.

FIG. 5 shows how the most-visited graphical view of combined clickstreams of a group could look like, for example when run from a browser extension on a desktop or laptop, or when run as an app on a mobile device. It is showing the five most visited web pages within the past hour for the group.

The data items that can be recorded from member users who opt-in to join and become active members in the group correspond closely to those used for an individual user.

The browsing histories can be linked to the personal and demographic information (e.g., name, age, gender, location) and contact information of the user (e.g., e-mail address, mailing address, phone), as provided by the user or as gleaned by the system from other sources on the user's Internet browsing device.

URL's/URI's are recorded when loaded in an Internet browsing device. A URL/URI is recorded if any one of the following conditions is met:
a. The loaded URL/URI stays loaded for at least a pre-set interval of time;
b. The user navigates away from the loaded URL/URI within a pre-set interval of time; and
c. The Internet browsing device's tab/window that displays the loaded URL/URI is moved to the background by bringing another window/tab to the foreground within a pre-set interval of time.

The pre-set interval of time applicable to a-c can be chosen by the user, such as selected from a list of pre-defined times (for example 0.5, 1, 2, 3, 5, 10 s), or can be set to a value chosen by the user. The application initially assigns the pre-set interval of time a default value, such as 5 s.

Time data can be recorded for each URL/URI and can comprise the time stamp (e.g., in Coordinated Universal Time (UTC)) of when URL/URI is recorded, and, optionally, the length of time spent on a URL/URI before navigating away or bringing another tab or window to the foreground or into focus.

Other web page properties that can be recorded include one or more of: Web page title (e.g., from value in the <Title> HTML tag if available); Referrer (e.g., the HTTP referrer as defined by the W3C (i.e., current web page accessed by clicking on a hyperlink from the previous web page); the Web page that was previously loaded before manually typing in a new web page address; and the Web page of the previous tab if another tab is brought to the foreground); thumbnails of web pages, generated by a separate thumbnail server accessing saved URLs so that no personalized/private content is in the thumbnails; favicons (a set of icons associated with a particular Web Site or Web Page) of URLs (domains) visited; Viewport scrolling coordinates when “Surfing Together” (an activity during which members of the group access the same web-site at the same time); Flag for marking a web page as a favorite; Notes dropped on web pages (free form content created and saved for oneself or for others associated with a URL/URI); Browser type and version used to view the web page; and Operating system type and version used to view the web page. It is to be understood that this list is not exhaustive or exclusive and that other properties of web-pages can be recorded in addition to or in place any one of the foregoing properties. Ways to accomplish “surfing together” are described in copending application Ser. No. 14/______, filed Jul. 31, 2014, entitled “Synchronized Web-browsing”, having first-named inventor Yoon, David, and attorney docket no. 1757-00-003U01, incorporated herein by reference.

From the most visited list view, viewers (either users or third parties who have permission to view the data) can choose to see, either in tabular/textual view or graphical view, what URL's/URI's, as a group, the members visit from any of the URL's/URI's on the list. In other words, for each URL/URI, there can be, depending on the available data, a set of URL's/URI's that users navigated to from the source URL/URI. This set of URL's/URI's can be ranked and displayed in terms of the number of times they were accessed by the group members. These “subsequent” URL's/URI's are thus listed in terms of rankings from most often/popular to least often/popular. Aggregating the referrer URL/URI data is what makes this functionality possible.

The lists of URL's/URI's created thereby can also be searched for key words in the titles, the text of the URL/URIs, as well as of the text of the contents of the HTML.

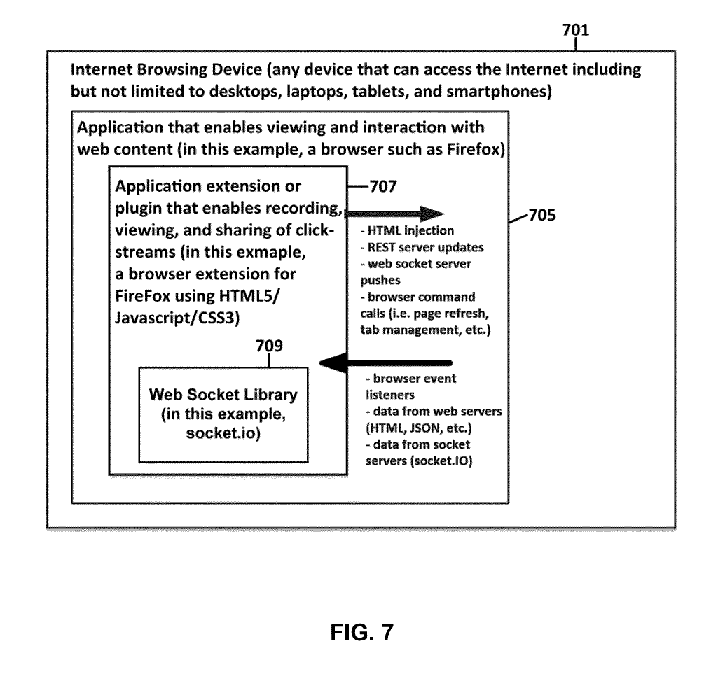

FIG. 6 shows example of a tabular/textual view of the combined clickstreams of a group. For each of the URL's, the title of the webpage, the address, a summary icon denoting its popularity, a time-on-page, and the date last accessed are shown. Each of the columns can be sorted, and the data can be exported to a portable file format. Although not shown, URL's/URI's can be deleted by marking them (e.g., by checking a box in the last column) and then selecting “delete” from the “Choose Action” drop down. It is to be understood that the tabular view in FIG. 6 is exemplary: other tabular views are consistent with the technology described herein, including views having the same columns in different positions, and columns showing other types of pertinent data.

### EXEMPLARY IMPLEMENTATIONS

The technology can be implemented to run within a web-browser, for example on a desktop personal computer or a laptop or notebook or tablet computer. The technology can also be implemented to run as an “app” (or application program) that runs on a mobile device such as a mobile or cellular phone, a personal digital assistant, or a tablet such as an iPad. When implemented to run within a browser, the technology is typically developed as a “browser extension” because it can be developed using existing browser capability, rather than as a plug-in. Different existing web-browsers refer to extensions differently: for example, FireFox refers to such an object as an “add-on” where Safari, Internet Explorer, and Chrome refer to them as “extensions”. However, plug-in based implementations for any of the browsers are not precluded. When implemented to run as an app, the app also provides basic browser functionality.

It is further contemplated that the technology run in a client-server implementation, whereby the user logs in or otherwise connects from an Internet Browser Device to a server that provides the functionality for clickstream monitoring.

The computer functions for managing a user's clickstreams, as described herein, can be developed by a programmer skilled in the art. The functions can be implemented in a number and variety of programming languages, including, in some cases mixed implementations. For example, the functions as well as scripting functions can be programmed in C, C++, Java, Python, HTML5, CSS3, JavaScript, Perl, .Net languages such as C#, and other equivalent languages. The capability of the technology is not limited by or dependent on the underlying programming language used for implementation or control of access to the basic functions. Alternatively, the functionality could be implemented from higher level functions such as tool-kits that rely on previously developed functions for manipulating URL's.

The technology for monitoring, recording, and displaying clickstreams, as described herein can be developed to run with any of the well-known computer operating systems in use today, as well as others, not listed herein. Those operating systems include, but are not limited to: Windows (including variants such as Windows XP, Windows95, Windows2000, Windows Vista, Windows 7, and Windows 8, available from Microsoft Corporation); Apple iOS (including variants such as iOS3, iOS4, and iOS5, iOS6, iOS7, and intervening updates to the same); Apple Mac operating systems such as OS9, OS 10.x (including but not limited to variants known as “Leopard”, “Snow Leopard”, “Mountain Lion”, “Lion”, and “Mavericks”); the UNIX operating system (e.g., Berkeley Standard version); and the Linux operating system (e.g., available from Red Hat Computing).

To the extent that a given implementation relies on other software components, already implemented, such as functions for accessing or manipulating web-pages, those functions can be assumed to be accessible to a programmer of skill in the art.

Furthermore, it is to be understood that the executable instructions that cause a suitably-programmed computer to execute methods for managing a user's clickstreams, as described herein, can be stored and delivered in any suitable computer-readable format. This can include, but is not limited to, a portable readable drive, such as a large capacity “hard-drive”, or a “pen-drive”, such as connects to a computer's USB port, and an internal drive to a computer, and a CD-Rom or an optical disk. It is further to be understood that while the executable instructions can be stored on a portable computer-readable medium and delivered in such tangible form to a purchaser or user, the executable instructions can be downloaded from a remote location to the user's computer, such as via an Internet connection which itself may rely in part on a wireless technology such as WiFi. Such an aspect of the technology does not imply that the executable instructions take the form of a signal or other non-tangible embodiment. The executable instructions may also be executed as part of a “virtual machine” implementation.

The technology described herein can be implemented in many different ways, of which one exemplary way is as follows.

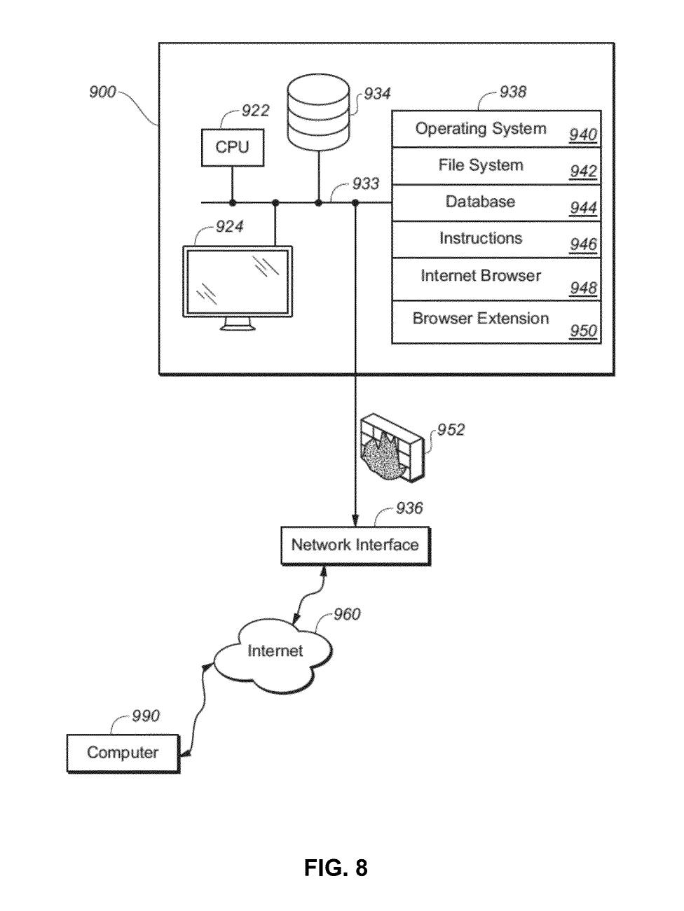

The context of a client implementation is shown in outline in FIG. 7. In this particular example, an internet browsing device such as a laptop 701, running a web-browser 705 such as FireFox with a custom browser extension 707 represents the client. The clickstream monitoring software resides in the extension 707; such an extension enables the recording, viewing, and sharing of clickstreams.

Packaged within the custom browser extension is a web socket library 709 such as socket.IO that enables communication through WebSockets (a standard protocol) with a socket server. The browser extension can be built using HTML5, CSS3 and JavaScript to offer a user interface that enables users to control what clickstream data is being recorded, and what clickstream data to share while providing various ways of viewing the data. This is facilitated by event listeners and data exchanges between the browser and the browser extension through the browser add-on architecture.

Synchronous data, including logging in, is communicated between the web server and browser extension using REST and JSON while asynchronous data such as clickstream data retrieval and updates is communicated between the socket server and the browser extension's client socket library using WebSockets.

API communication between the server and client is implemented over the REST or WebSockets layers, depending on the need for synchronous or asynchronous data exchange. This implementation is within the capability and knowledge of one of skill in the art.

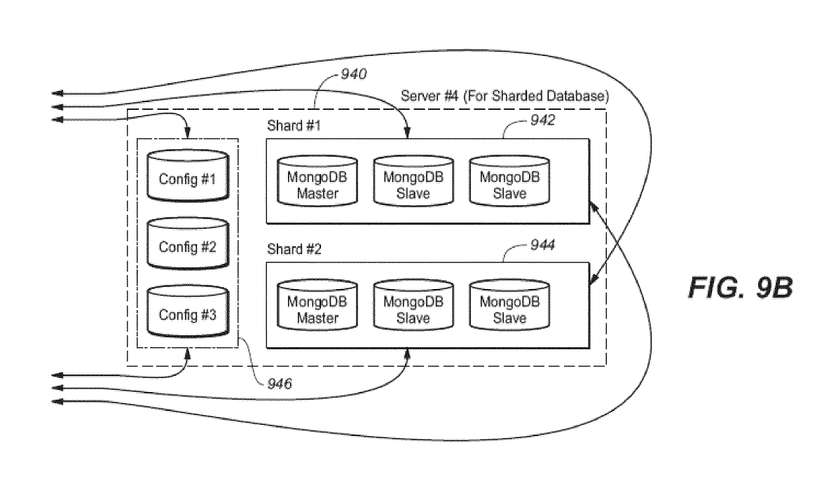

An exemplary server implementation is shown with respect to FIG. 9. It should be noted that simple implementations that rely on single threaded and multiple threaded instances of server use can be implemented with the capability of those of skill in the art. Such implementations address simple situations where a user connects to the server and wishes to, for example, share information about a newly-visited webpage to other members of a group. Web servers such as Tornado can handle multiple such requests from multiple users. Preferably the server utilizes a load-balancing layer.

A preferred embodiment of a database server for use with the clickstream technology herein is shown schematically in FIG. 9. Various functions are distributed over several different servers (or server clusters) 1210, 1220, 1230, and 1240. Client side communication begins with browser 1201 having a plugin 1203 (resident on a computer or a mobile device). Communications are channeled through a server-side load balancer 1205 before being distributed out amongst the various servers.

In this particular example, a NoSQL database such as MongoDB 1213, 1223, 1242, 1244 is employed so as to provide a flexible database structure. A flexible structure is important because it enables the storage of individual clickstreams while providing the ability to group them in various ways without having to restructure tables as a traditional SQL database would require. The logic for data queries and updates can be performed using the python programming language via the PyMongo interface. API's that clients can call are sourced from the PyMongo interface and exposed using either the REST of Socket.IO interfaces through the web server.

The technology also provides for Application Servers 1220 (includes the Portal, REST, static, session, and social server instances). An application server that provides the logic to render web pages on the Portal which enables users to view and manage their accounts and data in greater detail than through the browser extension can be constructed using Python and Django, with the Tornado web server serving up the pages to maximize flexibility and performance. The application server uses the same API calls as the browser extension in order to re-use as much of the database querying and update logic built using PyMongo as possible.

The technology also provides for a thumbnail Server 1230. In this embodiment, a separate server acts as the thumbnail server which loads URL's/URI's in recorded clickstreams and takes snapshots of the web pages so that they can be displayed by the clients. Various users 1232 (denoted as workers ##1-4) communicate web-page thumbnails to queue 1236, and thereafter to a thumbnail generator server 1238. Server 1238 accesses the web-page by URL/URI and takes a snapshot of it to create a thumbnail, provided for example that a recent version of it is not already available in its cache. The web page snapshots taken do not contain any private data as they are loaded by a 3^{rd} party server which has no personal information from any user. Thumbnail generation is managed by a queue to maximize efficiency. Static server 1234 serves up unchanging or relatively slowly changing material.

The technology also provides for a Socket Server 1210, as shown in FIG. 9. The Socket Server can be implemented using the Socket.IO library and is exposed through the Tornado web server, with the Tornado extension implemented to enable real-time persistent connections for WebSockets. Due to the single-threaded method in which the Tornado server functions, implementing the Socket.IO library requires the implementation of a multi-threading and multi-processing architecture in order to prevent blocking.

A sharded database for maximum efficiency can be handled by server 1240. Three config servers (##1-3) will hold the meta data for the two sharded clusters. They will be deployed on three separate server instances to assure immediate data consistency and reliability.

The multi-threaded architecture involves a single web server process servicing many worker threads that process requests in parallel.

The multi-processing architecture also involves scaling the multi-threaded system to many processors (either machines or virtual systems) using load balancers.

### Computing Apparatus

An exemplary general-purpose computing apparatus 900 suitable for practicing client-side methods described herein is depicted schematically in FIG. 98. Such a system could be used by any user who wishes to monitor and record their clickstreams, as described herein.

The computer system 900 comprises at least one data processing unit (CPU) 922, a memory 938, which will typically include both high speed random access memory as well as non-volatile memory (such as one or more magnetic disk drives), a user interface 924, one more disks 934, and at least one network connection 936 or other communication interface for communicating with other computers over a network, including the Internet 960, as well as other devices, such as via a high speed networking cable, or a wireless connection. There may optionally be a firewall 952 between the computer 900 and the Internet 960. At least the CPU 922, memory 938, user interface 924, disk 934 and network interface 936, communicate with one another via at least one communication bus 933.

Memory 938 stores procedures and data, typically including some or all of: an operating system 940 for providing basic system services; one or more application programs, such as a web-browser 948 and a browser extension 950, and a compiler (not shown in FIG. 9), a file system 942, one or more databases 944 that store data such as clickstreams or user or group data, and optionally a floating point coprocessor where necessary for carrying out mathematical operations. The methods of the present technology may also draw upon functions contained in one or more dynamically linked libraries, not shown in FIG. 9, but stored either in memory 938, or on disk 934.

The database and other routines shown in FIG. 9 as stored in memory 938 may instead, optionally, be stored on disk 934 where the amount of data in the database is too great to be efficiently stored in memory 938. The database may also instead, or in part, be stored on one or more remote computers that communicate with computer system 900 through network interface 936, according to methods as described herein.

Memory 938 is encoded with instructions 946 for at least: carrying out recording operations; manipulating URL's/URI's; and for accessing database records. In some embodiments, the database is not stored on the computer 900 that performs the display or monitoring but is stored on a different computer (not shown) and, e.g., transferred via network interface 936 to computer 900.

Various implementations of the technology herein can be contemplated, particularly as performed on one or more computing apparatuses of varying complexity, including, without limitation, workstations, PC's, laptops, notebooks, tablets, netbooks, and other mobile computing devices, including cell-phones, mobile phones, and personal digital assistants. The computing devices can have suitably configured processors, including, without limitation, graphics processors and math coprocessors, for running software that carries out the methods herein. In addition, certain computing functions are typically distributed across more than one computer so that, for example, one computer accepts input and instructions, and a second or additional computers receive the instructions via a network connection and carry out the processing at a remote location, and optionally communicate results or output back to the first computer.

Control of the computing apparatuses can be via a user interface 924, which may comprise a display, mouse, keyboard, and/or other items not shown in FIG. 9, such as a track-pad, track-ball, touch-screen, stylus, speech-recognition device, gesture-recognition technology, human fingerprint reader, or other input such as based on a user's eye-movement, or any subcombination or combination of inputs thereof.

The manner of operation of the technology, when reduced to an embodiment as one or more software modules, functions, or subroutines, can be in a batch-mode—as on a stored database of URL's/URI's, processed in batches.

The clickstreams can be displayed in tangible form, such as on one or more computer displays, such as a monitor, laptop display, or the screen of a tablet, notebook, netbook, or cellular phone. The clickstreams, can further be printed to paper form, stored as electronic files in a format for saving on a computer-readable medium or for transferring or sharing between computers, or projected onto a screen of an auditorium such as during a presentation.

Certain default settings can be built in to a computer-implementation, but the user can be given as much choice as he or she desires over the features that are used in recording and monitoring clickstreams.

### Example

### www.beenpod.com

An exemplary embodiment of the technology herein as implemented on a smartphone, such as one running Apple iOS, can be found at www.beenpod.com.

All references cited herein are incorporated by reference in their entireties.

The foregoing description is intended to illustrate various aspects of the instant technology. It is not intended that the examples presented herein limit the scope of the appended claims. The invention now being fully described, it will be apparent to one of ordinary skill in the art that many changes and modifications can be made thereto without departing from the spirit or scope of the appended claims.

What is claimed:

1. A computing apparatus for managing a user's clickstreams, the apparatus comprising:
an Internet connection;
a computer-readable memory, encoded with instructions;
a processor executing the instructions;
wherein the instructions provide for:
recording a user's clickstream, wherein the clickstream comprises two or more URL's from the user's Internet session;
associating one or more pieces of user-specific information with each of the two or more URL's; and
sharing the clickstream with one or more third parties.

2. The computing apparatus of claim 1, wherein the one or more pieces of user-specific information are selected from the group consisting of: name, age, gender, location, e-mail address, and telephone number.

3. A method for managing a user's clickstreams, the method comprising:
recording a user's clickstream, wherein the clickstream comprises two or more URL's from the user's Internet session;
associating one or more pieces of user-specific information with each of the two or more URL's; and
sharing the clickstream with one or more third parties,
wherein the method is performed on a computing apparatus.

4. A computer-readable medium encoded with instructions for implementing the method of claim 3.

5. A computing apparatus for displaying a user's clickstream, the apparatus comprising:
an Internet connection;
a computer-readable memory, encoded with instructions;
a processor executing the instructions;
wherein the instructions provide for:
recording the clickstream of a user, wherein the clickstream comprises one or more URL's from the user's Internet session;
storing the clickstream in a database;
generating an icon for each of the one or more URL's based on the length of time spent by the user at the URL; and
displaying, on a computer display, the icon for each of the one or more URL's.

6. The apparatus of claim 5, wherein the instructions further comprise:
associating one or more pieces of user-specific information with each of the one or more URL's in a user's clickstream; and
storing the one or more pieces of information in the database in conjunction with the stored URL.

7. A method for displaying a user's clickstream, the method comprising:
recording the clickstream of a user, wherein the clickstream comprises one or more URL's from the user's Internet session;
storing the clickstream in a database;
generating an icon for each of the one or more URL's based on the length of time spent by the user at the URL; and
displaying, on a computer display, the icon for each of the one or more URL's;
wherein the method is performed on a computing apparatus.

8. The method of claim 7, further comprising:
associating one or more pieces of user-specific information with each of the one or more URL's in a user's clickstream; and
storing the one or more pieces of information in the database in conjunction with the stored URL.

9. A computer-readable medium encoded with instructions for implementing the method of claim 7.
